(19) United States
(12) Patent Application Publication
(10) Pub. No.: US 2015/0213477 A1
(43) Pub. Date: Jul. 30, 2015

(54) REWARD METHOD, PROGRAM AND SYSTEM

(71) Applicant: CECILIA NOGUEIRA CALMON SOBRAL, SAO PAULO (BR)

(72) Inventor: CECILIA NOGUEIRA CALMON SOBRAL, SAO PAULO (BR)

(73) Assignee: CECILIA NOGUEIRA CALMON SOBRAL, CHICAGO, IL (US)

(21) Appl. No.: 14/168,949

(22) Filed: Jan. 30, 2014

(51) Int. Cl. G06Q 30/02

(52) U.S. Cl. CPC G06Q 30/0226; G06Q 30/0213

(57) ABSTRACT

The present invention relates generally to a reward method, program and system of executing a software application on an electronic device, more specifically, to software applications for conducting financial transactions, information registering and reward points permuting transactions via a portable device.

### FIELD OF THE INVENTION

The present invention relates generally to a new reward method, program and system of executing a software application on an electronic device, more specifically, to a software application for conducting financial transactions, information registering and reward points permuting transactions via an electronic device.

### BACKGROUND OF THE INVENTION

The intense global competition has forced all kinds of companies to improve the relation with the customer, once it is much more costly for the companies to get new customers than it is to retain the ones they already have. In this sense reward programs has been showed as a great manner to attract new customers and keep the ones that the companies have already, creating in this sense a loyalty network. More specifically, customer loyalty strategies are all about attracting the right customer, getting them to buy, buy often, buy in higher quantities and bring you even more customers. The loyalty techniques may comprise:

Customer's appreciation: keeping touch using email marketing, phone calls, cards and more.

Individuality: showing that you care and remembering what the customers like and don't like.

Rewards: rewarding the customers for choosing you over your competitors.

Encourage: figuring out how to make the customers more success, happy and joyful.

and others.

In order to attract and retain customers, credit card companies, airlines, hotels, car rental companies, chain retailers, telecom providers, etc. have historically introduced frequent incentive programs that offer awards concerning to a transaction with the credit card, distance traveled, or daily bookings related to that customer. Users often may earn reward points as part of a transaction with a merchant or issued by a credit card company or a distributor. The reward points are usually tracked in a reward point account stored on a reward point server computer managed by the merchant, issuer or a third party service provider. In addition, credit card issuers may implement their own reward point system.

Additionally, loyalty programs may be initiated by businesses to actively cultivate loyalty amongst customers to ensure they continue patronizing the business, as well as to acquire information relating to customer spending habits. Loyalty programs may be structured marketing efforts that reward, and therefore encourage, continued and regular buying behavior with a particular business. In addition to reward points, loyalty programs may offer prizes, discounts, and other inducements designed to incentivize repeat business from customers. Loyalty programs span through a broad spectrum of industries, including, for example, frequent-flyer programs for airline customers, gas cards for gas station patrons, rewards cards that accumulate reward points for repeated use of a credit or debit card, priority club programs for hotel reservations and automobile rentals, and customer loyalty programs for restaurants, hardware stores, grocery stores, electronic stores, department stores, etc., or for frequent use of a website or online service.

As an example, airline frequent flyer programs operate concerning to the award points or miles based on the distance or cost of an airplane trip (or on the value of the customer to the airline rather than its distance or cost).

Many programs offer redemption programs in which the user may trade in, or redeem, his reward points in exchange for goods, services, or discounts.

Additionally to the reward strategy above, online social networks are increasingly being recognized as an important source of information influencing the choice and use of products and services. Nowadays, information sharing comprises one of the most valuable marketing for different purposes. Application software, social networks, blogs, micro blogging services, news feeds, websites, e-mail subscriptions and other social utilities are widely used by merchants and individuals to share information via Internet, the information comprising for example ratings, comments, pictures, news, events, products and services, etc. This type of massive information sharing is also called “viral marketing”.

In other words, the viral marketing comprises, for example, video clips, interactive Flash games, advergames, ebooks, brandable software, images, text messages, email messages, or web pages which are shared by the authors and the public in self-replicating processes for their contact media and network. According to the Opinion Research Corporation, one person who has a good online experience may turn share it with 12 more people in average. By the same token, if one person has a bad experience, 12 others may also know about it. This is the dynamic that powers viral marketing: a chain effect.

In this context, the spontaneous marketing became a powerful tool for selling products or services, through a reliable and cheap mean: customers. It is very understandable that one person may accept information much more easily from a friend than from a spamming marketing add. Friends' opinion comprises, beyond simple information, a dense content of reliability and compatibility of taste. When one person makes his or her choice public (sharing the information through social media, for example), such choice may be seen by his friends with other load of meaning: an advice. By the chain effect, friends who got the advice may share with friends and so on.

Due to the effectiveness of the spontaneous marketing and the reward loyalty programs, companies start to encourage individuals to share advertisement through rewarding programs, wherein the dynamic promotion is associated with a merchant; and in response to one or more interactions by other users with the dynamic promotion, the program calculates a reward for the user that is redeemable in a transaction with the merchant.

Several patent documents disclose different types of methods and systems to perform a reward program.

US 20120303433 relates to an online reward exchange system and method of operation, which includes an exchange computer that interoperates via a computer network with user computers, reward point issuer computers, and merchant computers. The merchants' products may be purchased by a user by requesting an issuer(s) to redeem reward points in exchange for payment to the merchant for the product. The exchange computer is the gateway to the system and manages various transactions such as providing online product catalogs to users that list the merchants products, as well as displaying to the user the reward points he has available in his reward programs with the issuers. Once a user selects a desired product the exchange computer may mediate or manage the purchase transaction in which reward points are redeemed by the selected issuer and consideration is conveyed to the merchant in exchange for the merchant providing the product to the user.

US 20070130011 relates to a system and method for operating a reward points accumulation and redemption program wherein a user earns rewards from a plurality of independent reward issuing entities, with each tracking the user's earned. A trading server accumulates some or all of the user's earned rewards from the reward servers and credits the accumulated rewards into a single reward exchange account associated with the user. The user may then select an item for purchase with the accumulated rewards. The item is provided to the user in exchange for a subset or all of the rewards. Reward points may also be redeemed in exchange for services, such as the playing of a video game or Internet access.

US20130304559 discloses systems, methods, devices and computer program products are disclosed for conducting transactions using an electronic device. A method of executing a software application on an electronic device includes: determining, via the electronic device, a location of the device; displaying, via the electronic device's display, a plurality of merchants within a predetermined proximity of the device's location; receiving, via a user input device, a selection corresponding to at least one of the merchants; displaying, via the display device, a balance of virtual rewards points available for redemption by the user of the device; displaying, via the display device, an exchange value of the virtual rewards points for making a purchase associated with the selected merchant; and, responsive to a purchase request received via the user input device, authorizing deduction of the exchange value from the balance of the virtual rewards points and providing confirmation of the purchase.

Finally, US20130290084 describes a computer-implemented method, computerized apparatus and computer program product. The method performed by a computerized device. The method comprising: publishing on a social network platform a dynamic promotion, wherein the dynamic promotion is attributed to a user, wherein the dynamic promotion is associated with a merchant; and in response to one or more interactions by other users with the dynamic promotion, calculating a reward for the first user that is redeemable in a transaction with the merchant.

Face to the prior art documents, all the rewarding programs try to corner the customer through loyalty programs as reward programs, then the preference of the customer is not due to the quality of the service or products offered, but due to strategic game mechanics, where the company makes customers feel as if they're being rewarded immediately and continuously from your communications. In turn, they'll be more inclined to buy because they feel the company has been giving them value all along.

What is desired therefore is to provide a reward program, method and system where a user who shares an information (hereinafter called holder user) in a network is rewarded by the other user(s) (hereinafter called second user or receptor(s)) of the same network, who thought that information was useful. Furthermore, said reward is made over a transaction of transference of points between the respective points accounts associated with the users. Thereafter, the points may be stored in an user's point account, wherein a balance of virtual rewards is available for redemption by the user. In this sense, it is presented and described a new reward method, program and system of executing a software application on an electronic device, more specifically, to software applications for conducting financial transactions, information registering and reward points permuting transactions via an electronic device.

### Objectives of the Invention

One of the main objectives of the present invention is to provide a computerized reward method, program and system of executing a software application on an electronic device together with the benefits of the viral marketing.

Another objective of the present invention consists to provide a database of information which may be accessed by a portable electronic device of receptors accordingly to their lifestyle, profile or interests.

Another objective of the present invention consists to provide a reward program and system to connect the information holder user and the receptors of such information, accordingly to the satisfaction of the receptors of such information.

Another objective of the present invention consists to provide a tool of instantaneously interaction between the users of the present system.

### BRIEF DESCRIPTION OF THE DRAWINGS

FIG. 1 shows a diagram of a preferred embodiment of the present invention;

FIG. 2 shows a second diagram of a preferred embodiment of the present invention.

### DETAILED DESCRIPTION OF THE DRAWINGS

While the present invention is susceptible of embodiment in many different forms and aspects, the principles of the invention or inventions disclosed herein is not intended to limit the broad aspects. To that extent, elements and limitations that are disclosed, for example, in the Abstract, Summary, and Detailed Description sections, but not explicitly set forth in the claims, should not be incorporated into the claims, singly or collectively, by implication, inference or otherwise. For purposes of the present detailed description, unless specifically disclaimed, the singular includes the plural and vice versa; the words “and” and “or” shall be both conjunctive and disjunctive; the word “all” means “any and all”; the word “any” means “any and all”; and the word “including” means “including without limitation.” Moreover, words of approximation, such as “about,” “almost,” “substantially,” “approximately,” and the like, may be used herein in the sense of “at, near, or nearly at,” or “within 3-5% of,” or any logical combination thereof, for example.

The present invention relates generally to a reward method, program and system of executing a software application on a but not limited to a portable electronic device, more specifically, to software applications for conducting financial transactions, information registering and reward points permuting transactions via an electronic device.

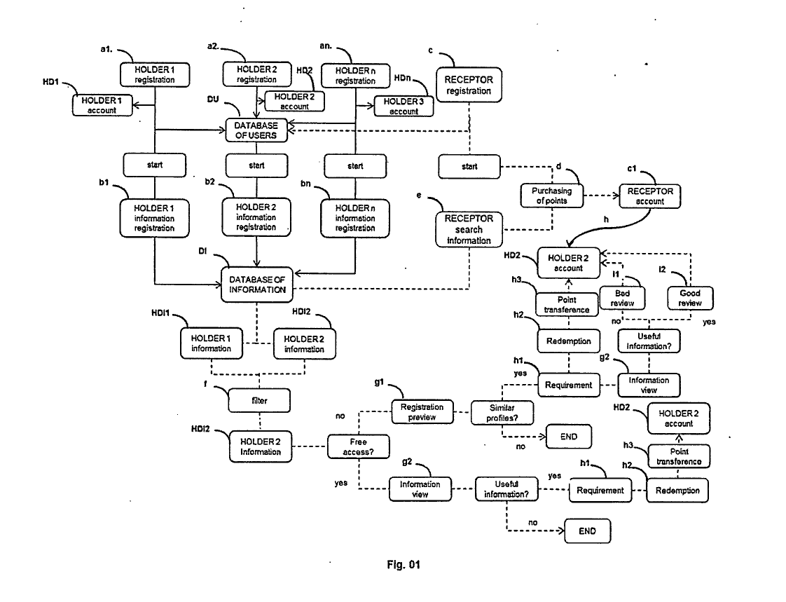

Accordingly to the FIG. 1, the present invention describes a reward program comprising a method of executing a software application on an electronic device, said method comprising:

Registration (a1, a2, an) of a least one first user or holder (HD1, HD2, HDN) in a database of users (DU) via the electronic display device;

Registration (b1, b2, bn) of at least one information by said holder (HD1, HD2, HDN) in a database of information (DI) via the electronic display device;

Registration (c) of at least one second user or receptor in said database of users (DU) via a second electronic display device;

Purchasing (d) a number of points by the receptor through a means of purchasing of points, said points being stored in a point account associated to said receptor (c1) via the second electronic display device;

Searching information (e) performed by the receptor in the said database of information (DI) via the second electronic display device;

Accessing (g2) the information selected via the second electronic display device;

Requirement (h1) of at least one point from said point account associated to the receptor (c1) via the second electronic display device;

Redemption (h2) of at least one point from said point account associated to the receptor (c1) via the second electronic display device;

Transaction of point transference (h3) of at least one point from said point account associated to the receptor (c1) to through a means of direct transfer of points to a point account associated to a holder (HD2); the said points being permutable by benefits.

The said electronic device comprises a housing or casing and includes one or more input devices, which comprises various devices such as a keyboard, buttons on a button panel, a single or multi-touch screen, a track ball, a track pad, a microphone, or voice and/or gesture recognition software and hardware. Examples of some electronic devices include, for example, cellular phones and smartphones, laptop computers, tablet computers (e.g., the Samsung GALAXY TAB tablet device and the Apple IPAD tablet device), e-readers (e.g., the KINDLE electronic reader device), personal digital assistants (PDA), etc. Said electronic device may also be a portable electronic device, by portable, it is meant that the device may be comfortably held in the hand or hands of an adult human and weighs a couple to a few pounds. For output, the electronic device may include, for example, a display device, which may include a high-resolution liquid crystal display (LCD) panel, a plasma display, or a light emitting diode (LED) or organic LED (OLED) display; one or more speakers, one or more user-accessible ports (e.g., an audio output jack for headphones, a video headset jack, etc.), and other conventional I/O devices and ports. The electronic display device may be configured to display embodiments of the present software application, as well as other tangential features, functions and information, for example, messaging, emails, alerts and announcements, personal information, advertisements, and the operating status of the electronic device. In some embodiments, the electronic device may also comprise a location tracking device, which may include a global positioning system (GPS) receiver. The user-input device(s) accept(s) user input(s) and transforms the user input(s) to electronic data signals indicative of input or inputs, which may correspond to an enabled feature for such input(s) at a time of activation. The input(s), once transformed into electronic data signals, may be outputted to a central processing unit (CPU) or controller for processing. The electronic data signals may correspond, for example, to an electrical current, an electrical voltage, an electrical charge, an optical signal, or a magnetic signal.

The said communications network may be a wired or a wireless network, or a combination of wired and wireless technology. In at least some embodiments, most if not all of the transaction functions (e.g., purchasing or transference of points) described herein by the electronic device may be conducted over a wireless network, such as a WLAN. The system may also consist in a web-based system where users access internet-based websites and/or web-based applications to access the transaction and information features disclosed herein. In various aspects, the electronic device includes a web browser or a dedicated, standalone application software, or a combination thereof. A web browser typically allows the user to search for and/or request a web page (e.g., from the server) with a web page request. A web page, in a non-limiting example, is a data file that includes computer executable or interpretable data, graphics, text, video, and/or sound, that may be executed, displayed, played, processed, streamed, and/or stored, and that may contain links to other web pages.

Electronic devices which execute the present software application are not limited to work only in a communication network. In some aspects, the present invention may store all the information registered by the users in a memory of the present software and, once connected in a communication network the software may automatically upload the information previously stored (“off line” services).

Alternatively, the transaction software automatically makes requests with the web browser. Examples of commercially available web browser software include, for examples, FIREFOX, available from the Mozilla Corp., of Mountain View, Calif., SAFARI available from Apple, Inc., and INTERNET EXPLORER, available from Microsoft Corp., of Redmond, Wash.

Communication may take place through any known media, such as telephone lines (e.g., Dial-Up), local area network (LAN) or wide area network (WAN) links (e.g., Ethernet, T(X) lines, X.25, etc.), broadband connections (e.g., Integrated Service Data Network (ISDN), Frame Relay, etc.), wireless links (e.g., infrared, Bluetooth®, WiFi or WLAN), cellular networks, etc. The network may carry Transmission Control Protocol/Internet Protocol (TCP/IP) protocol communications, and HTTP/HTTPS requests made by a web browser and associated responses and replies, and the connection between user software and a server may be communicated over such TCP/IP networks. Examples of networks that may serve as the communications network include a wireless or wired Ethernet-based intranet, a local or wide-area network (LAN or WAN), and/or the global communications network known as the Internet, which may be configured to accommodate many different communications media and protocols.

The application software may be implemented in various forms. For example, the application software may be in the form of a web-based (e.g., Java) applet that is downloaded to the electronic device and runs in conjunction with a web browser on the electronic device. Optionally, the software may be in the form of a separate software application, which may be implemented in a multi-platform language such as .Net or Java, or in native processor executable code.

In some embodiments, the present software of the electronic device communicates with a single “host” or “user” server, which in turn conducts any necessary communications with one or more “third party” servers to complete a particular transaction. Optionally, the present application software and web browser may be part of a single client-server interface, where the software may be implemented as a “plug-in” to the web browser. Other optional variations and known alternatives are considered to be within the scope and spirit of the present invention.

The various components of the electronic device are controlled by one or more processors (e.g., CPU, distributed processors, etc.), also referred to herein generally as a controller (e.g., microcontroller, microprocessor, etc.). The controller may include any suitable processor(s). For example, the controller may include a plurality of microprocessors including a master processor, a slave processor, and a secondary or parallel processor. Controller, as used herein, may comprise any combination of hardware, software, and/or firmware disposed inside and/or outside of the housing of the device that is configured to communicate with and/or control the transfer of data between the electronic device and a bus, another computer, processor, or device and/or a service and/or a network. The controller is generally operable to execute any of the computer program products, software, applications, algorithms, methods and/or other processes disclosed herein. The controller may include a memory device or may be coupled to a memory device, which may comprise a volatile memory (e.g., a random-access memory (RAM) or multiple RAM) and a non-volatile memory.

Location and movement of the electronic device may be tracked via a location tracking device, which may reside in the electronic device. As indicated above, the location may be determined through a satellite-based GPS navigation system. Even without a GPS receiver, the electronic device may provide location and movement information through cooperation with a cellular system through a process known as “trilateration.” A cellular system's towers and base stations communicate radio signals and are arranged into a network of cells. A cellular device, such as cellphones, smartphones and cellular-enabled tablet computers, have low-power transmitters for communicating with the nearest tower, base station, router, or access point. As a user moves with the cellular device, e.g., from one cell to another, the base stations monitor the strength of the transmitter's signal. When the cellular device moves toward the edge of one cell, the transmitter signal strength diminishes for a current tower. At the same time, the base station in the approaching cell detects a strength increase in the signal. As the user moves into a new cell, the towers transfer the signal from one to the next. A computer may determine the location of the device based on measurements of the transmitter signal, such as the angle of approach to the cell tower(s), the time it takes the signal to travel to multiple towers, and the strength of the signal when it reaches the towers. According to other aspects of the present invention, a movement sensor may be provided comprising one or more sensors configured to determine the movement (e.g., rotation, translation, etc.) of the electronic device with respect to an established data or reference (e.g., position, spatial orientation, reaction, force, velocity, acceleration, electrical contact, etc.) about or along one or more axes.

Still accordingly to the FIG. 1, one of the preferred embodiments of the present invention consists that the method further comprises a filtering step (f) according to the interests of the receptor (c), said filtering comprising: filtering the results (HD1, HD2) according to the characteristics of interest, said characteristics comprising at least one of the price, ratings or distance; selecting the information of interest, a selection corresponding to at least one of the information of interest (HDI2). The filtering step (f) works in order to the better accuracy with the user's (in this case, c) needs. For example: does the user have a lot of money with him? Does the user want to eat vegetarian food? Does the user want to be in an English speaker place?

One of the preferred embodiments of the present invention consists that the method further comprises the review (i1 and i2) of the holder information accessed by the receptor (c). The review step works in order to evaluate the reliability of the holder and its related information.

More specifically, the first step of the present invention, comprises the registration of the users (a1, a2, an, c) in a display of respective electronic device. One of the preferred embodiment of the present invention consists that the Registration step (a1, a2, an, c1) of the users comprises the fulfillment of a personal data form, said personal data being at least one of name, age, nationality, picture, gender and keywords via an electronic display device. After the fulfillment of such form the users (a1, a2, an, c), the user may press the confirmation button and the software automatically provides an identification number associated to the user's registration. The identification number identifies the user's registration account. One of the preferred embodiment of the present invention consists that there is a point account (HD1, HD2, HDN, c1) associated to the user registered with an identification number.

In some aspects of the preferred embodiment of the present invention consists that the users (a1, a2, an, c) may be a person, an establishment, an organization or a group thereof.

Once registered, users may have access, or partial access to the functionalities of the present software application: information registering (b1, b2, bn), the information search (e), other users profile, purchasing points (d), requirement (h1), redemption (h2) and point transference (h3) and, maybe, free access to some information from other users which determined it has a free access.

The user's account (HD1, HD2, HDN, c1) may comprise all the information concerned to the related user: number of points, pictures, data, information registered, credit card number, etc. In some aspects of the present invention the user may access his account from a different electronic device. The user may access the webpage related to the present software application, the webpage may require the user's identification number and password defined in the registration step (a1, a2, a3, c). After that the user may access all the information previously registered.

One of the preferred embodiment of the present invention consists that said information (b1, b2, bn) is at least one of an information concerning to an establishment, said establishment may be a restaurant, a bar, a park, an airport, a store, a street and an area; a public or a private establishment.

Another preferred embodiment of the present invention consists that said information (b1, b2, bn) is at least one of establishment's rating, an establishment's recommendation, establishment's warning, a help, an event, a check-in, a picture, a comment, a complaint or a denouncement.

One of the preferred embodiment of the present invention consists that the registration (b1, b2, bn) of an information comprises the sub-steps of:

i) the localization of the establishment;

ii) data of the establishment; said data comprising ate least one of the name, functions, references, and

iii) the information to be registered, said information comprising at least one of the compliments, rating, recommendation, warning, a help, advice, event, a check-in, a picture, a comment, a complaint, a denouncement concerning to the establishment.

In some aspects of the present invention the user may access the information registering screen via the display of the electronic device and may fulfill the data related to the establishment required by the software application. After typing the information to be registered, the user may press the authorization button to register the information in the database of information.

One of the preferred embodiment of the present invention consists that the registration (b1, b2, bn) of an information is stored in a database of information (DI) associated to the localization of the establishment and the user's point account's identification (HD1, HD2, HDN).

One of the preferred embodiment of the present invention consists that purchasing of points (d) comprises the purchase of points by the users (a1, a2, an, c1) is via an in-app purchase platform. For example, said in-app purchasing of points is like Amazon in-app purchase platform. The Amazon In-App Purchasing platform allows the software to present, process, and fulfill purchases of digital content and subscriptions.

One of the preferred embodiment of the present invention consists that the purchasing of points (d) comprises a financial transference from the user (c) via the electronic device by at least one of a credit card, a charge card, a debit card, a bank card, a smart card, or an automated teller machine card. The said financial transference may be done via the display of the electronic device.

One of the preferred embodiment of the present invention consists that the search information step (e) comprises the sub-steps of:

(i) determining a location of interest;

(ii) search via an electronic device's display device information according to the interest of the user, said information comprising at least one of the information concerning food, hotel, hospital, museum, park, club, sports or atm;

(iii) displaying, via an electronic device's display device, a plurality of information related to establishment (HDI1, HDI2) within a predetermined proximity of the location of interest.

The results may be presented in the display of the electronic device in a hierarchy order which may be determined concerning the preferences of the receptor (c): a) distance, b) price, c) if the merchant accept the points of the present reward program as a payment form, e) number of ratings, f) best ratings, and so on.

One of the preferred embodiment of the present invention consists that the search information step (e) comprises displaying the plurality of information (HDI1, HDI2) on a interactive map with respective location of each of the establishment and the location of the electronic device relative to the plurality of establishment (HDI1, HDI2) in the display of the electronic device.

Alternatively, the search information step (e) comprises to search other users of the present software who are within a determined distance of the user's electronic device. One of the preferred embodiment of the present invention consists that the search other users alternative step (e) comprises:

(i) determining a location of interest;

(ii) search via an electronic device's display other users who may be around;

(iii) displaying, via an electronic device's display, a plurality of previews related to other users within a predetermined proximity of the location of interest.

One of the preferred embodiment of the present invention consists that the holder (a2) of the selected information (HDI2) allows free access to the information registered by the receptors (c). The free access allowance is determined by the information holder (a1, a2, an) at the information registration step (b1, b2, bn).

One of the preferred embodiment of the present invention consists that the holder (a2) of the selected information (HDI2) charges the receptor (c) a predetermined number of points for the access of said information (HDI2). In one aspect of the present invention, the holder (a2) of the selected information, at the moment of the register of such information (b2) determines that, to access the said information, the receptor shall transfer a predetermined number of points from the receptor's account (c1) to the holder's account (HD2). The receptor may agree with such requirement and does the requirement (h1), the redemption (h2) and the point transference (h3). The receptor (c) may disagree with the requirement and in this way, the receptor has no access of such information.

One of the preferred embodiment of the present invention consists that if the access to the holder information (HDI2) is charged, the receptor is only available to access a registration preview (g1), said registration preview (g1) comprising the information data of the holder (a2).

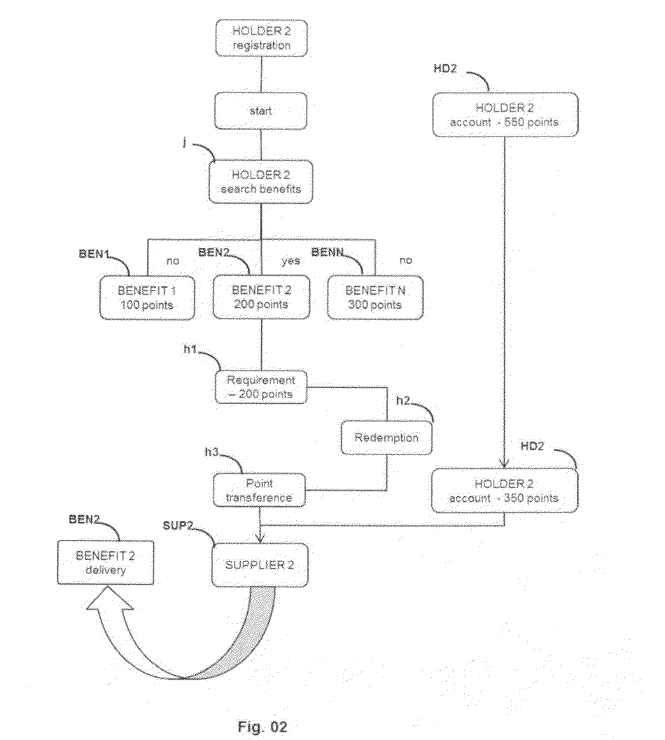

Accordingly to FIG. 2, once the holder (a2) receives an enough number of points the respective account (HD2), it is possible to permute said points by a benefit (BEN1, BEN 2, BENN) offered by a net of suppliers (SUP) associated with the present reward program. The suppliers (SUP) offer the benefits (BEN1, BEN2 BENN) in exchange of a predetermined number of points.

One of the preferred embodiment of the present invention consists that the present method further comprises the sub-steps of:

search (I) of benefits (BEN1, BEN2, BENN) by the holder (DH2), via the electronic display device;

filtering (m) the results (BEN2, BEN2, BENN) according to the interest of the holder (HD2), via the electronic display device;

Requirement (h1) of at least one point from said point account associated to the holder (HD2);

Redemption (h2) of at least one point from said point account associated to the holder (HD2);

Transaction of point transference (h3) of at least one point from said point account associated to the supplier (SUP2) through a means of direct transfer of points; said points being permutable by the benefit chosen (BEN 2), authorizing the deduction of the determined number of points from the holder account (HD2) and providing confirmation of the said transference to the supplier (SUP).

As described above, the permutation of points by benefits may be intermediate by the in-app purchase platform, for example, Amazon in-app purchase platform.

One of the preferred embodiment of the present invention consists that the receptor (c) performs the transference of points voluntarily among users.

One of the preferred embodiment of the present invention consists that the permutation of points by benefits (BEN2) is completed with the delivery of such benefit by the supplier (SUP).

The present invention also describes a computer reward program product for an electronic device, the computer reward program product comprising one or more non-transient computer-readable media including instructions which, when executed by one or more processors, cause the one or more processors to operate with one or more databases, input devices and one or more display devices to: Register a user in a database of users; register at least one information by said holder user of the information in a database of information; register at least a second user in said database of users; purchase a number of points by the second user through a means of purchasing of points, said points being stored in a point account associated to said second user; access of said database of information by said second user; perform a transaction of transference of at least one point from said second user to said holder user of the information through a means of direct transfer of points to a point account associated to said holder user; access a catalog of benefits by the holder user, said catalog of benefits is associated to a database of suppliers, said benefits being permutable by said points; redeem at least one point from said point account associated to said holder user by said holder user through a means of redemption of points and effecting a transaction of permutation of at least one of said points by the benefit chosen by the holder user through a means of permutation.

The present invention also describes a computer reward system for an electronic device, the system comprising: registration of a user by the user input device in a database of users; registration of at least one information by said holder user input device of the information in a database of information; registration of at least a second user by the second user input device in said database of users; said second user purchasing a number of points by the second user through a means of purchasing of points, and receiving said points over a wireless network at an electronic device a balance of rewards points associated with said second user point account stored on a points provider server remote from the electronic device; said second user accessing to said database of information and selecting an information of the holder user; receiving from the second user input device an indication of a desired number of points to transfer for a corresponding point account's identification of the holder user; the second user's electronic device communicating over the wireless network the desired number of points and point account's identification directly or through a host server; deducting the determined number of points from the stored number of points from de second user's point account to produce a modified stored number of points and displaying the modified stored number of points on the second user's display device; and the holder user's electronic device communicating over the wireless network the transferred number of points or the modified stored number of points in the point account's identification of said holder user directly or through the host server.

One of the preferred embodiment of the present invention consists that the points are non-currency.

One of the preferred embodiment of the present invention consists that the transference of the determined number of points from an user's point account and the point account's identification includes requesting an authorization from the points provider server for deduction of the corresponding number of the reward points and receiving from the reward points an indication as to whether the requested authorization was approved.

1. A reward program comprising a method of executing a software application on an electronic device, said method comprising:
Registration (a1, a2, an) of a least one first user or holder (HD1, HD2, HDN) in a database of users (DU) via the electronic device;
Registration (b1, b2, bn) of at least one information by said holder (HD1, HD2, HDN) in a database of information (DI) via the electronic display device;
Registration (c) of at least one second user or receptor in said database of users (DU) via the electronic device;
Purchasing (d) of a number of points by the receptor through a means of purchasing of points, said points being stored in a point account associated to said receptor (c1) via the electronic display device;
Searching information (e) performed by the receptor in the said database of information (DI) via the electronic display device;
Accessing (g2) the information selected via the electronic display device;
Requirement (h1) of at least one point from said point account associated to the receptor (c1) via the electronic display device;
Redemption (h2) of at least one point from said point account associated to the receptor (c1) via the electronic display device;
Transaction of point transference (h3) of at least one point from said point account associated to the receptor (c1) to through a means of direct transfer of points to a point account associated to a holder (HD2) via the electronic display device; the said points being permutable by benefits (BEN 1, BEN 2, BENN).

2. The method, according to claim 1 further comprising a filtering step (f) according to the interests of the receptor (c), said filtering comprising: filtering the results (HD1, HD2) according to the characteristics of interest, said characteristics comprising at least one of the price, ratings or distance; selecting the information of interest, a selection corresponding to at least one of the information of interest (HD2).

3. The method, according to claim 1 further comprising the review (i1 and i2) of the holder information (i1, i2) accessed by the receptor (c).

4. The method, according to claim 1 further comprising the steps of:
search (I) of benefits (BEN2, BEN2, BENN) by the holder (DH2), via the electronic display device;
filtering (m) the results (BEN2, BEN2, BENN) according to the interest of the holder (HD2), via the electronic display device;
Requirement (h1) of at least one point from said point account associated to the holder (HD2);
Redemption (h2) of at least one point from said point account associated to the holder (HD2);
Transaction of point transference (h3) of at least one point from said point account associated to the supplier (SUP2) through a means of direct transfer of points; said points being permutable by the benefit chosen (BEN 2), authorizing the deduction of the determined number of points from the holder account (HD2) and providing confirmation of the said transference to the supplier (SUP).

5. The method according to claim 1, wherein the user (a1, a2, an, c) may be a person, an establishment, an organization or a group thereof.

6. The method according to claim 1, wherein there is a point account (HD1, HD2, HDN, c1) associated to the user registered with an identification number.

7. The method according to claim 1, wherein said information (b1, b2, bn) is at least one of establishment's rating, an establishment's recommendation, establishment's warning, a help, an event, a check-in, a picture, a comment, a complaint or a denouncement.

8. The method according to claim 1, wherein the registration (b1, b2, bn) of an information comprises:
the localization of the establishment,
ii) data of the establishment, said data comprising ate least one of the name, functions, references, and
iii) the information to be shared, said information comprising at least one of the compliments, rating, recommendation, warning, a help, advice, event, a check-in, a picture, a comment, a complaint, a denouncement concerning to the establishment.

9. The method according to claim 1, wherein the registration (b1, b2, bn) of an information is stored in a database of information (DI) associated to the localization of the establishment and the user's point account's identification (HD1, HD2, HDN).

10. The method according to claim 1, wherein purchasing of points (d) comprises the purchase of points by the users (a1, a2, an, c1) is via an in-app purchase platform.

11. The method according to claim 1, wherein the search information step (e) comprises:
(i) determining a location of interest,
(ii) search via an electronic device's display device information according to the interest of the user, said information comprising at least one of the information concerning food, hotel, hospital, museum, park, club, sports or atm;
(iii) displaying, via an electronic device's display device, a plurality of information related to establishment (HDI1, HDI2) within a predetermined proximity of the location of interest.

12. The method according to claim 1, wherein the search information step (e) comprises displaying the plurality of information (HDI1, HDI2) on a map with a respective location of each of the establishment and the location of the electronic device relative to the plurality of establishment (HDI1, HDI2).

13. The method according to claim 11, wherein the search information step (e) comprises to search other users registered in the present software application who are within a determined distance from the electronic device.

14. The method according to claim 1, wherein the holder (a2) of the selected information (HDI2) permits free access to the information registered by the receptors (c).

15. The method according to claim 1, wherein the holder (a2) of the selected information (HDI2) charges the receptor (c) a predetermined number of points for the access of said information (HDI2).

16. The method according to claim 1, wherein if the access to the holder information (HDI2) is charged, the receptor is only available to access a registration preview (g1), said registration preview (g1) comprising the information data of the holder (a2).

17. The method according to claim 1, wherein the permutation of points by benefits (BEN2) is completed with the delivery of such benefit by the supplier (SUP).

18. A computer reward program product for an electronic device, the computer reward program product comprising one or more non-transient computer-readable media including instructions which, when executed by one or more processors, cause the one or more processors to operate with one or more databases, input devices and one or more display devices to: Register a user in a database of users; register at least one information by said holder user of the information in a database of information; register at least a second user in said database of users; purchase a number of points by the second user through a means of purchasing of points, said points being stored in a point account associated to said second user; access of said database of information by said second user; perform a transaction of transference of at least one point from said second user to said holder user of the information through a means of direct transfer of points to a point account associated to said holder user; access a catalog of benefits by the holder user, said catalog of benefits is associated to a database of suppliers, said benefits being permutable by said points; redeem at least one point from said point account associated to said holder user by said holder user through a means of redemption of points and effecting a transaction of permutation of at least one of said points by the benefit chosen by the holder user through a means of permutation.

19. A computer reward system for an electronic device, the system comprising: registration of a user by the user input device in a database of users; registration of at least one information by said holder user input device of the information in a database of information; registration of at least a second user by the second user input device in said database of users; said second user purchasing a number of points by the second user through a means of purchasing of points, and receiving said points over a wireless network at an electronic device a balance of rewards points associated with said second user point account stored on a points provider server remote from the electronic device; said second user accessing to said database of information and selecting an information of the holder user; receiving from the second user input device an indication of a desired number of points to transfer for a corresponding point account's identification of the holder user; the second user's electronic device communicating over the wireless network the desired number of points and point account's identification directly or through a host server; deducting the determined number of points from the stored number of points from de second user's point account to produce a modified stored number of points and displaying the modified stored number of points on the second user's display device; and the holder user's electronic device communicating over the wireless network the transferred number of points or the modified stored number of points in the point account's identification of said holder user directly or through the host server.

20. The system according to the claim 19, wherein the points are non-currency and convertible by a user of the user account to an amount of currency commensurate with the balance of reward points.
